(19) United States
(12) Patent Application Publication
(10) Pub. No.: US 2006/0089119 A1
(43) Pub. Date: Apr. 27, 2006

(54) Method and a device for scatternet formation in ad hoc networks

(76) Inventors: Jaakko Lipasti, Jorvas (FI); Yue Y. Wang, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/516,878

(22) PCT Filed: Jun. 2, 2003
(86) PCT No.: PCT/FI03/00433

§ 371 Date: Jul. 15, 2005

(30) Foreign Application Priority Data
Jun. 3, 2002 (FI) 200221065

(51) Int. Cl. H04M 3/16

(52) U.S. Cl. 455/410; 455/411

(57) ABSTRACT

The invention relates to a method and a device for scatternet formation in a wireless ad hoc networks, a device (306) executing the described method tries to establish connections (318) to as many devices as allowed utilizing applicable search techniques (312), such as inquiry and inquiry scan in case of Bluetooth connections. If only a single connection is allowed for the device (306), it is made with a device responded first to an inquiry. When existing connections occasionally fail or are intentionally broken, new ones will be searched for a replacement.

The present invention relates generally to a method and a device for scatternet formation in ad hoc networks. The invention especially concerns networks supporting Bluetooth technology.

Bluetooth specification [1] by Bluetooth SIG (Special Interest Group) consists of two documents: the Foundation Core including actual design specifications and the Foundation Profile comprising interoperability guidelines and protocol definitions. Bluetooth provides technology for short-range wireless communications, and important usage of Bluetooth is to enable short-range ad hoc PAN (Personal Area Network) networks. Bluetooth utilizes the unlicensed frequency band at 2.4 GHz and devices supporting this de facto standard share 79 channels with channel spacing of 1 MHz. In a few countries (e.g. France) frequency band is reduced, and a 23-channel system is utilized. Frequency hopping technique is used to reduce interference/fading and on the other hand, enhance security. On the slotted channel, information is exchanged through packets. Each packet is transmitted on a different hop frequency. A basic packet covers a single slot, but can be extended to cover up to five slots. Bluetooth supports both asynchronous and synchronous communications.

Bluetooth device consists of a radio unit, a link control unit, and a support unit for link management and host terminal interface functions. The aforesaid specifications determine these functionalities in a more detailed manner.

Bluetooth enables different types of connections, the simplest of which, “point-to-point” connection, consisting of only two devices called a master and a slave. Procedures “inquiry” and “paging” are used to establish new connections between devices. Inquiry procedure enables a unit to discover which units are in range, and what their device addresses and clocks are. A master executing the inquiry procedure hops 3200 times per second according to a 32-channel inquiry hopping sequence as a slave executing inquiry scan process adjusts the monitored frequency once in 1.28 seconds. After the inquiry procedure is completed, a connection can be established by the paging procedure and only the Bluetooth device address is required to set up a connection. However, knowledge about the clock will accelerate the setup procedure. The unit that establishes a connection will carry out a page procedure and automatically act as the master of the connection.

When two or more devices are connected together via Bluetooth using the same channel, they are said to form a piconet including 2-8 active units, one unit acting as a master and others as slaves. In addition, more slaves can remain locked to the master in a so-called parked state. These parked slaves are still synchronized to the master. All data is transmitted between the master and the slaves resulting that the communication between slaves has to be routed through the master. Related topology is thus star-shaped. Each Bluetooth device has a unique 48-bit device address derived from the IEEE802 standard and each slave active in a piconet has an individual active member address. The all-zero active member address is reserved for broadcast messages and the master does not have a member address at all. Active member address is assigned to the slave by the master, when the slave is activated.

Inside a piconet, the master of the piconet controls the traffic by polling the slaves. Due- to the stringent Time-Division Duplex (TDD) scheme, slaves can communicate directly only with the master. A slave is allowed to transmit data if it was addressed (by the master) in the previous time slot. A master can poll a slave either implicitly or explicitly. When the master has data available for a particular slave and it wants to give that slave an opportunity to transmit, the master sends a data packet to the slave. This case is called implicit poll. The polled slave responds with a data packet if available. Otherwise, it responds with a NULL packet. An explicit poll takes place when a master has no data available for a particular slave while the master wants to give that slave an opportunity to transmit. In this case the master sends a packet with no payload (POLL packet). The master can poll slaves according to any preferred algorithm such as Round Robin and Fair Exhaustive Polling (FEP). With Round Robin polling, slaves are polled in a cyclic manner whether they have data to transmit or not. When a piconet consists of a master and seven slaves, each slave gets a seventh of the total number of available polls. Bandwidth is lost on lightly loaded slave and cannot be used by other slaves. The FEP was introduced to solve the inefficiency problem of Round Robin poller. Slaves are divided into two groups: active group and inactive group. Slaves in the active group are polled in a Round Robin manner. The number of successive useless polls or the average success rate of polls can be used as a measurement of activity of a slave. If the traffic demand is known in advance, the FEP can be set up to divide bandwidth between slaves in more efficient way.

Slaves can join in several piconets within the same coverage area on a time-division multiplex basis. Multiple piconets containing shared devices form a multi-hop network called a scatternet. Independent piconets belonging to a scatternet are not synchronized and each piconet still has its own hopping channel. Even a master of a certain piconet can become a slave in another piconet. A device belonging to several piconets can provide inter-piconet routing services. Currently, only the specification of the star-shaped single-hop piconet is ready and many crucial issues of scatternets such as network formation, inter-piconet scheduling and routing, are not well specified.

In general, PAN is a concept that is bearer independent. It can be built over Bluetooth, WLAN (Wireless Local Area Network) or IR (Infra-Red). PANs just allow devices to work together and share each other's information and services. Communication between PANs would enable participants at a meeting to share documents or presentations. Access to the Internet via a wireless LAN (Local Area Network) access point or via a 3G cellular phone would enable devices in the PAN to be constantly on-line.

Usually an ad-hoc PAN is expected to operate in a network environment in which some or all the nodes are mobile. The network is to be formed without any central administration or infrastructure. Ad hoc PAN has the following characteristics:
Dynamic network topology: The ad-hoc network nodes are free to move arbitrarily. Therefore the network topology may change randomly and rapidly at unpredictable time. Nonetheless, connectivity in the network should be maintained to allow applications and services to operate undisrupted. In particular, this will influence the design of routing protocols and in the Bluetooth case, network formation.
Distributed operation: An ad hoc network node can't rely on a network in the background to support functions such as naming, addressing, security and routing. These functions must be operated efficiently under distributed conditions.
Bandwidth-constrained, variable capacity links: Wireless links will continue to have significant lower capacity than their hardwired counterparts. In additional, the realized throughput of wireless communications—after accounting for the effects of multiple access, fading, noise, and interference conditions, etc—is often much less that a radio's maximum transmission rate.
Low-power devices: Most of the nodes in an ad-hoc network use batteries or other exhaustible means for their energy. For these nodes, a very important system design criteria for optimisation is energy conservation.

From the Bluetooth radio technology point of view, a Bluetooth network is different from the typical ad hoc network in many ways as the network structure is hierarchical (roles: master-slave), radio ranges are short, explicit connections are required (inquiry, page), connection set-up times can be long and bit-rates are reasonably low.

The current specified Bluetooth PAN is based on a single piconet, but the scatternet functionality is required to allow a flexible forming of larger ad-hoc PANs. The nodes that are present in multiple piconets may either have applications that are operating in different piconets, or merely function as a gateway between the piconets and forward other nodes' traffic.

Bluetooth units can be arranged to establish a scatternet applying various methods. The configuration of a scatternet has a great effect on the functioning of the network. For instance, when a scatternet contains a large number of piconets in the same area, the rate of packet collisions correspondingly increases. Therefore, before the power of Bluetooth ad hoc network can be fully exploited, an efficient protocol to form a scatternet from standalone Bluetooth devices has to be developed. By grouping devices into piconets and properly selecting the bridge units executing the inter-piconet routing functionalities, resulting scatternet performance figures like network throughput can be significantly altered.

Inter-piconet scheduling is another necessary mechanism for utilizing Bluetooth scatternet. Since a Bluetooth unit can transmit or receive on only one piconet at a time, bridging unit must switch between piconets on a time division basis. Due to the need to synchronize its radio from one piconet to another and perform the necessary signalling, a Bluetooth unit necessarily loses some time while switching. The inter-piconet scheduling issues represent an important performance constraint in building scatternets. The connection point between two piconets can receive packets from one piconet and forward them to the other piconet. When packets must traverse multiple hops between the source and destination, routing becomes necessary. Bluetooth networks have ad hoc nature, i.e. participants are normally mobile, continuously moving in and out of its range and the communication should be established without aid of a central infrastructure. The existing ad hoc routing protocols developed by IETF working group “MANET” (Mobile Ad-hoc NETwork) can be considered as the candidate routing protocols for Bluetooth scatternet. But because Bluetooth ad hoc network has particularities compared to the “typical” ad hoc network, behaviour of MANET routing protocols such as AODV (Ad Hoc On-Demand Distance-Vector) over scatternet has not been fully tested yet.

A study by Miklos et al. [2] covers relationships between scattemet design rules and performance parameters for deriving generic guidelines. According to the study, two characteristics, namely the amount of bridging overhead and the number of established Bluetooth links, have a major impact on system performance. It seems that for a good performance, it is fundamental to decrease bridging overhead as much as possible and the number of established Bluetooth links has to be controlled by the exploited scatternet formation technique.

Law et al. [3] discloses a new Bluetooth scatternet formation protocol, which produces scatternets with some desired properties: a small number of piconets for minimizing inter-piconet interference, and low device degrees (the number of piconets that a device belongs to) for avoiding network bottlenecks. However, a restrictive assumption that all Bluetooth devices are in range with each other has been made.

Scatternet topologies providing optimal performance are definitely of prime importance for future Bluetooth implementations. However, the complexity of the problem and the large number of various, adjustable parameters usually makes the network formation algorithms quite complicated and slow. Furthermore, existing algorithms try to optimise the network topology according to a limited set of parameters usually in a static state; all devices are located inside the radio range and/or their position is fixed; devices do not move and therefore existing links do not fail, new link possibilities do not appear, link qualities do not vary etc. As a result, the corresponding results gathered from the simulations are not fully transformable to real life scenarios that often comprise highly dynamic characteristics.

In traditional “on-demand” resource management solutions, for example, establishment of connections is based on requests from the unconnected devices, possibly resulting a decoupling of some existing connections to free resources for the new requested one. Generally speaking, also a demand based paging process in a computer system may comprise steps of receiving a request of a new memory page needed by an application and dumping of the prevailing page in favour of the requested new one. A selection of a page to be dumped may be done on the basis of various mechanisms such as “least-recently used”, “most recently used”, “least-used” etc.

The object of the present invention is to alleviate the drawbacks of the typical network formation techniques mentioned above. The invention discloses a method and a device, such as a wireless personal communications device like a mobile terminal, for chatternet formation. The proposed method is fast, simple and capable of adapting to dynamic environment originating e.g. from movements of the near-by Bluetooth devices and varying traffic patterns. A clear difference between traditional “on-demand” resource management solutions and the disclosed method is founded on the basic principle of the invention. In proposed solution, new connections are searched and established by devices with free resources, even without actual demand from the outside devices. Correspondingly, existing connections may be automatically terminated based on some connection specific characteristics in order to enable establishment of new connections with more favourable features.

According to the invention, a method for wireless ad hoc network formation, where the forming is to be performed by a device operable in a wireless network, is characterized in that it comprises the steps of
checking if more connections are allowed for said device,
inquiring for other devices in range,
connecting to a device responded first.

In another aspect of the invention, a method for wireless ad hoc network formation, where the forming is to be performed by a device operable in a wireless network, is characterized in that it comprises the steps of
acquiring parameters from existing connections,
checking if parameter related criteria for breaking a connection is met,
breaking an existing connection,
inquiring for other devices in range,
connecting to a device responded first.

In a further aspect of the invention, a device operable in a wireless network, comprising processing means and memory means for processing and storing instructions and data, is characterized in that it is arranged to check if more connections are allowed for said device and if that is the case, arranged to inquire for other devices in range and connect to a device responded first.

In a further aspect of the invention, a device operable in a wireless network, comprising processing means and memory means for processing and storing instructions and data, is characterized in that it is arranged to acquire parameters from existing connections, check if parameter related criteria for breaking a connection is met, and if that is the case, arranged to break an existing connection with criteria met, inquire for other devices in range, and connect to a device responded first.

The term “link” refers to a connection between two devices. The devices are called “nodes”.

In one embodiment of the invention a mobile terminal is arranged to construct a scatternet in accordance with the proposed method. The terminal is originally a slave member of an existing piconet but it still has free resources for setting up a new connection. The terminal executes the inquiry procedure to detect if other devices are present and willing to establish a connection. The terminal connects to a device replied first and eventually, a new piconet is formed. Now the resulting scatternet consists of two piconets having said terminal as a bridge node connecting said piconets.

In another embodiment of the invention a node recognises a break in an existing connection and automatically starts looking for a replacement.

In a further embodiment of the invention a node monitors existing links and according to predefined or adaptively calculated criteria, breaks a certain connection for a search of a new and advantageously more favourable one.

In a further embodiment of the invention a node without any existing connections inquires for neighbours and after setting up few connections, still continues responding to inquiries from other devices until the predefined connection quota is full.

In the following, the invention is described in more detail by reference to the attached drawings, wherein

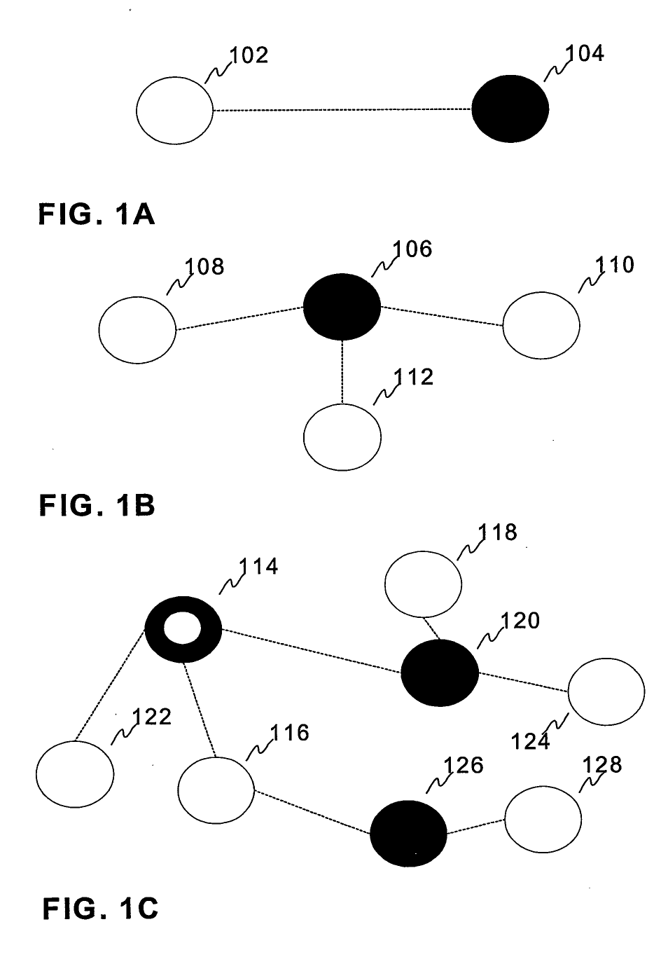

FIGS. 1A, 1B and 1C illustrate different connections supported by Bluetooth technology: single-slave, a (multi-slave) piconet and a scatternet.

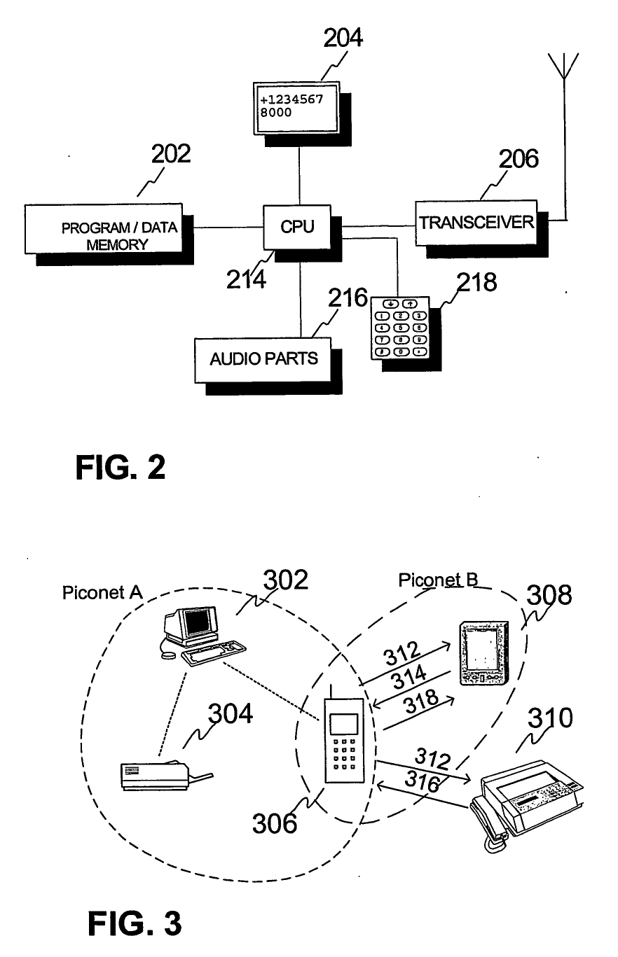

FIG. 2 is a block diagram of a device such as a personal communications device, capable of executing the presented method for scatternet formation.

FIG. 3 illustrates a method according to a first embodiment of the invention, wherein a piconet consists of two links and three nodes 302, 304 and 306. Node 302 is the original master while nodes 304 and 306 are the slaves. Devices 308 and 310 are not members in an existing piconet. Node 306 executes the method for constructing a scatternet resulting two piconets connected together by said node.

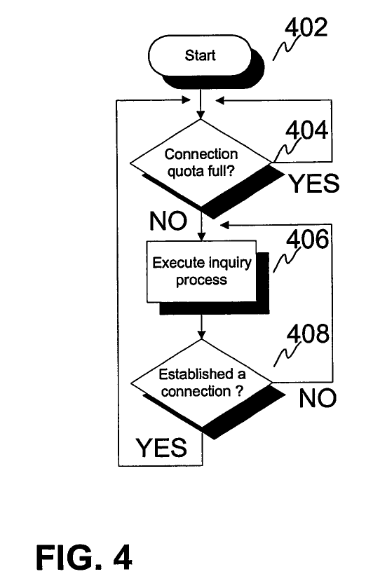

FIG. 4 is a flow diagram disclosing a first embodiment of the invention

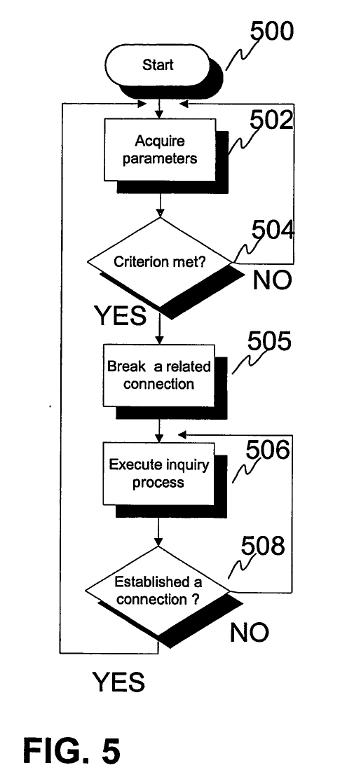

FIG. 5 is a flow diagram disclosing a third embodiment of the invention

Referring to FIGS. 1A, 1B and 1C, all independent Bluetooth devices are presented as circles, master nodes as filled and corresponding slaves as clear ones. 1A depicts a simplest communication scenario comprising a single slave 102 connected to a master 104. In 1B, a master node 106 is connected to three slave units 108, 110, 112 forming a typical star-shaped piconet topology. The third FIG. 1C illustrates a different network structure comprising shared nodes 114, 116 belonging to several piconets. Shared bridge node 114 has a versatile role; it is a master of a piconet 114, 116, 122 and a slave of a piconet 114, 118, 120, 124. Another bridge node 116 acts as a slave in both piconets 114, 116, 122 and 116, 126, 128.

Between master and slave(s), different links can be established. Two link types have been defined: Synchronous Connection-Oriented (SCO) link and Asynchronous Connection-Less (ACL) link.

The SCO link is a point-to-point link between a master and a single slave in the piconet. The master maintains the SCO link by using reserved time slots at regular intervals. The ACL link is a point-to-multipoint link between the master and all the slaves participating on the piconet. In the slots not reserved for the SCO link(s), the master can establish an ACL link on a per-slot basis to any slave, including the slave(s) already engaged in an SCO link. SCO and ACL links can be set up by exploiting aforesaid inquiry and paging procedures. The SCO link is a symmetric, point-to-point link between the master and a specific slave. The SCO link reserves slots and can therefore be considered as a circuit-switched connection between the master and the slave. The SCO link typically supports time-bounded information like voice. The master can support up to three SCO links to the same slave or to different slaves. A slave can support up to three SCO links from the same master, or two SCO links if the links originate from different masters. SCO packets are never retransmitted. The master will send SCO packets at regular intervals, the so-called SCO interval TSCO (counted in slots) to the slave in the reserved master-to-slave slots. The SCO slave is always allowed to respond with an SCO packet in the following slave-to-master slot unless a different slave was addressed in the previous master-to-slave slot. If the SCO slave fails to decode the slave address in the packet header, it is still allowed to return an SCO packet in the reserved SCO slot. A slave is permitted to return an ACL packet in the slave-to-master slot if and only if it has been addressed in the preceding master-to-slave slot. If the slave fails to decode the slave address in the packet header, it is not allowed to transmit. ACL packets not addressed to a specific slave are considered as broadcast packets and are read by every slave. If there is no data to be sent on the ACL link and no polling is required, no transmission shall take place. However, physical and logical channels, packets, utilized channel coding solutions, states used in the link controller, activity modes, audio and security issues etc. do not belong into the actual scope of this invention and thus not described here more deeply. More information can be found from Bluetooth specifications if required.

Referring to FIG. 2, basic components of a Bluetooth device, such as a modern personal communications device capable of executing a proposed method for scatternet formation, are presented. Memory 202 and processing unit 214 are required for processing and storing instructions (computer program) and data. A display 204 and a user interface 218 are typically needed for providing necessary device control and data visualization means to the user, although not necessary for executing the proposed method. Data transfer means like transceiver 206 handle the actual data transmission over an air interface. Audio parts 216 include e.g. optional transducers and amplifiers necessary for interfacing acoustic signals such as speech and music with said device. As the method of the invention can be implemented as code, it may be delivered on a carrier medium like a floppy disk, memory card or CD.

FIG. 3 depicts a communication scenario according to the first embodiment of the invention. Note that in this example, the maximum number of simultaneous connections per node is limited to two units only for simplification purposes. Node 302, a desktop computer with in-built Bluetooth capability, has initiated the forming of the network by executing the inquiry and page procedures as described in the Bluetooth specifications. Node 304, a laser printer, has been set to listen and respond to the inquiries by executing inquiry scan and page scan routines. Thus node 304 has been connected as a slave to master node 302. Next, node 306, a mobile terminal supporting communication over Bluetooth, is e.g. carried into range of the master 302 and also connects to the master 302, which now has its connection quota (2) full. The connection quota may be stored in the node as a parameter etc. Node 306 starts an inquiry procedure 312 as it has a free link to “spend” for a new connection with another device thus building up a scatternet. Both unconnected nodes 308, a PDA (Personal Digital Assistant), and 310, a fax machine, originally not in range (normally max. 10 meters) of the master node 302, scan for inquiries and answer 314, 316 to the inquiry 312 but node 308 is a bit faster in responding. Therefore, node 306 chooses to connect to node 308 as it reacted first, by sending a page-message 318 to it. Now a scatternet comprising two piconets, A (slaves 304, 306 with master 302) and B (slave 308 with master 306), is formed. Node 306 acts as a bridge between said two piconets (master in B and slave in A) and cannot subsequently connect to node 310 as its (306) connection quota is now full. However, node 310 could join an evoked scatternet if either of nodes 304 or 308 decided to execute the suggested method and found node 310 to be in range.

When the selection of far-end nodes for new connections is based on simple ‘first-to-response’ type mechanism, resulting network topology can be considered somewhat random in some cases. For example, if several devices are continuously executing the described method, it is obviously hard to estimate how the devices are finally connected to each other, which of them end up a master or a slave etc. On the other hand, referring to aforementioned studies about network formation, even pretty complicated algorithms do not necessarily perform well or at least predictably in a dynamic environment with several devices moving out (/in) of range and/or breaking (/establishing) connections. Thus the proposed simple and fast method is likely to offer benefits in cases where large-scale computations are futile e.g. because of a large number of dynamically acting devices.

Aforementioned scheduling and routing methods are essential parts of a complete scatternet implementation, although routing capabilities like the ones provided by MANET are not necessary in the actual scatternet formation phase but later in the inter-piconet data exchanging phase, therefore the routing algorithms are not discussed here any further.

In order to realize time division multiplexing between piconets, the current Bluetooth specification suggests to put links into a power save mode in order to leave a piconet and be able to join another piconet. Since two devices of a specific link can only communicate if both devices take part in the same piconet at the same time, negotiation and distribution of piconet presence schedules are required between devices. Baatz et al. [4] proposed a mechanism to support scatternet communication by using “presence point” concept and modified “sniff” mode. This approach defined presence points for each inter-piconet link at which communication may start. It enables each device to quickly determine whether the peer device is in the same piconet or not. If yes, the communication may start. Otherwise, another presence point may be tried without losing much bandwidth.

The sniff mode is one of the three low power modes currently specified for Bluetooth. Sniff mode allows a slave to lower its duty cycle, i.e. it is required to listen to the master only in certain sniff slots. Since communication between two devices continues as long as data is exchanged in sniff modes, it has dynamic nature that makes it suitable for scatternet scheduling. The sniff slots are regarded as possible presence points at which peer devices may start communicating. Additional, a credit scheme that is based on a priority scheme is used to decide when to abort an ongoing sniff slot in order to use an upcoming sniff slot. The simulation results show that this approach is able to rapidly adapt to changing traffic conditions because of low coordination overhead. And link level fairness is achieved through a slot accounting scheme that is able to reallocate unused bandwidth following the idea of max-min fairness.

Recall that a Bluetooth device can act as a slave in several piconets, but as a master only in a single piconet: if two networks with the same master are synchronized and use the same hopping sequence, they are actually one and the same piconet. A master or slave can become a slave in another piconet by being paged by the master of this other piconet. On the other hand, a unit participating in one piconet can page the master or slave of another piconet. Since the paging unit always starts out as master, a master-slave role exchange is required if a slave role is desired.

There are several occasions when a master-slave (MS) switch is desirable. Firstly, a MS switch is necessary when a unit paging the master of an existing piconet wants to join this piconet, since, by definition, the paging unit initially is master of a “small” piconet only involving the pager (master) and the paged (slave) unit. Secondly, when a slave in an existing piconet wants to set up a new piconet, involving itself as master and the current piconet master as slave. The latter case implies a double role of the original piconet master; it becomes a slave in the new piconet while still maintaining the original piconet as master. Thirdly, a much more complicated example is when a slave wants to fully take over an existing piconet, i.e., the switch also involves transfer of other slaves of the existing piconet to the new piconet. Clearly, this can be achieved by letting the new master setup a completely new piconet through the conventional paging scheme. However, that would require individual paging of the old slaves, and, thus, take unnecessarily long time. Instead, letting the new master utilize timing knowledge of the old master is more efficient. As a consequence of the MS switch, the slaves in the piconet have to be transferred to the new piconet, changing their timing and their hopping scheme. More detailed information about MS switching can be found from the Bluetooth specifications.

Whether the node executing the proposed method should be a master or a slave, or alternatively change its master/slave role for a new connection, is not a trivial question with an obvious solution. For example, if data exchange inside piconets is massive but between piconets more occasional, it is probably sensible to designate bridge nodes as slaves for not to cause congestion inside the piconets and vice versa.

Furthermore, the connection quota originally set to limit the maximum number of simultaneous connections can be made dependent e.g. on the current role of the related node. For example, if the node was designated as a master in some connection, the number of connected slaves could be totally omitted from the calculation of existing links performed during the execution of described method. Then, only the number of connected masters (to which said node is seen as a slave) would be compared against a predefined or adaptively calculated limit. Naturally, also a separate limit could be set to the maximum number of slaves of said node.

FIG. 4 includes a flow diagram disclosing the described first embodiment of the invention. After method start-up 402, the number of existing connections is checked and compared to the defined connection quota limit, see phase 404. For example, the limit may be based on the current traffic statistics, number of connected slaves (if the node executing the method is a master in a piconet) or whatever parameter that has been found useful. If new connections can still be established, the inquiry procedure is applied in phase 406. Depending on the situation, the exploited mechanism can either be actual inquiry or inquiry scan. When established a connection 408 with the node replied first, the method can be restarted from the beginning.

Alternatively, if the node executing the method has free capacity for several new connections and more than one response is actually received, the node may directly establish as many connections as possible (and allowed) without restarting the algorithm. Method restarting or step re-executing can be, for example, either continuous or periodical (e.g. timed) action.

In a second embodiment of the invention the node executing the algorithm monitors existing links and if some of them breaks e.g. due to movement of nodes away from each other, the node immediately starts to seek for a replacement connection. Otherwise the situation is congruent with the first embodiment.

In a third embodiment, see the flowchart in FIG. 5, after method initiation 500, a node monitors its existing links by e.g. storing connection specific parameters 502 and based on predefined or adaptively updated criteria 504, breaks a connection e.g. performing worst 505 for a search 506 of a new and hopefully more favourable connection 508. After establishing a new connection, the method can be restarted. One possibility for criterion can e.g. be related to the amount of data transmitted over a certain link, and if the link seems to be dormant, it can be broken. Criteria can be completely fixed or at least partially adaptive (e.g. periodically updated). For example, the average amount of data transmitted over links connected to the node executing the method can be continuously or intermittently calculated, stored and finally used for determining an “activity” limit under which none of the links is allowed to fall, otherwise that particular connection will be cancelled.

The fourth embodiment of the invention relates to a network formation initiated completely from scratch so nodes have no existing connections. Next, the embodiment is described with reference to nodes in FIG. 3 of the first embodiment. This time node 302 executing the proposed method sends standard inquiries targeted for all in-range devices, but only two nodes, 304 and 306, accept the request to join in a new piconet. Node 308 is configured to reject communication requests from other devices and node 310 is out of range. Connection quota has been set to 5 so node 302 still has a possibility to set up three extra connections. Therefore, node 302 starts scanning inquiries sent by others while maintaining an established piconet comprising nodes 302, 304 and 306. An inquiry by PDA node 308 is finally received by the node 302, which then joins another piconet consisting of devices 302 (a slave) and 308 (a master). Node 302 now acts as a shared device in two piconets. It continues to receive and respond to inquiries from other devices until the connection quota is full.

Many aspects of presented embodiments can be generalized to a simplified basic concept, where the role of the device executing the method (master/slave) as well as the exact nature of existing connections can be considered partially irrelevant. In this case, a device just tries to connect to as many devices as allowed utilizing different search techniques for finding compatible devices, such as inquiry and inquiry scan in case of Bluetooth connections. When existing connections occasionally fail or are intentionally broken, new ones will be searched for a replacement. Proposed solution clearly differs from traditional “on-demand” based methods.

The scope of the invention can be found from the following independent claims. However, utilized devices with Bluetooth support, decision-making criteria etc. may vary significantly depending on the current communication scenario, still converging to the basic ideas of the invention. For example, feasible Bluetooth devices include mobile terminals, PDAs, printers, scanners, laptop/desktop computers, and basically any kind of devices comprising necessary components for supporting already existing Bluetooth specifications and capable of executing the presented method. Therefore, the invention is not strictly limited to the embodiments described above.

### REFERENCES

[1] Bluetooth Specifications: Foundation Core, Foundation Profile 1.1, URL: http://www.bluetooth.com/dev/specifications.asp, Bluetooth SIG, February 2001.
[2] G. Miklos, A. Racz, Z. Turanyi, A. Valko, P. Johansson, Performance Aspects of Bluetooth Scattemet Formation, MobiHoc 2000, Boston Mass., August 2000.
[3] C. Law, A. K. Mehta, K. Siu, Performance of A New Bluetooth Scattemet Formation Protocol, MIT
[4] S. Baatz, M. Frank, C. Martini, and C. Scholz, Adaptive Scattemet Support for Bluetooth using Sniff Mode, Proceeding of he IEEE Conference on Local Computer Network, LCN 2001, Tampa, Fla., November 2001.

1. A method for wireless ad hoc network formation, where the forming is to be performed by a device operable in a wireless network, characterized in that said method comprises the steps of
checking if more connections are allowed for said device (404),
inquiring for other devices in range (406),
connecting to a device responded first (408).

2. A method of claim 1, characterized in that if more connections are not allowed, the step of checking (404) is repeated until the condition allowing a new connection is met.

3. A method of claim 1, characterized in that the maximum number of allowed simultaneous connections is dependent on the current role of said device.

4. A method of claim 1, characterized in that if several new connections are allowed for said device and more than one response is received, as many connections as allowed and available are established during said connecting phase.

5. A method of claim 1, characterized in that the step of inquiring (406) is repeated until a connection to another device is established.

6. A method of claim 1, characterized in that it is to be performed when an existing connection fails.

7. A method of claim 1, characterized in that said connection is established substantially utilizing Bluetooth technology.

8. A method of claim 7, characterized in that said method further includes a step of temporarily leaving a current piconet in order to connect to a device (408) not belonging to said current piconet, still maintaining existing connections in said current piconet by utilizing time division multiplexing.

9. A method of claim 1, characterized in that said device executing said method retains its role for a new connection.

10. A method of claim 1 characterized in that said device executing said method switches its role as a master or a slave for a new connection.

11. A method of claim 7, characterized in that said inquiring is executed substantially as INQUIRY or INQUIRY SCAN procedure.

12. A method for wireless ad hoc network formation, where the forming is to be performed by a device operable in a wireless network, characterized in that said method comprises the steps of
acquiring parameters from existing connections (502),
checking if parameter related criteria for breaking a connection is met (504),
breaking an existing connection (505),
inquiring for other devices in range (506),
connecting to a device responded first (508).

13. A method of claim 12, characterized in that if parameter related criteria for breaking up a connection is not met, the execution of the first two steps (502, 504) is repeated until the condition for a breaking a certain connection is met.

14. A method of claim 12, characterized in that said inquiry step is repeated until a connection to another device is established.

15. A method of claim 12, characterized in that said criteria concerns the amount of traffic transmitted through an existing connection.

16. A method of claim 12, characterized in that said criteria is adaptively updated.

17. A method of claim 12, characterized in that said connection is established substantially utilizing Bluetooth technology.

18. A method of claim 17, characterized in that said method further includes a step of temporarily leaving a current piconet in order to connect to a device (508) not belonging to said current piconet, still maintaining existing connections in said current piconet by utilizing time division multiplexing.

19. A method of claim 12 characterized in that said device executing said method retains its role (slave) for a new connection.

20. A method of claim 12, characterized in that said device executing said method switches its role as a master or a slave for a new connection.

21. A method of claim 17, characterized in that said inquiring (506) is executed substantially as INQUIRY or INQUIRY SCAN procedure.

22. A computer program comprising code means adapted to perform the steps of the method of claim 12 when said program is run on a computer.

23. A carrier medium carrying the computer executable program of claim 22.

24. A device operable (206) in a wireless network, comprising processing means (214) and memory means (202) for processing and storing instructions and data, characterized in that said device is arranged to check if more connections are allowed for said device and if that is the case, arranged to inquire for other devices in range and connect to a device responded first.

25. A device of claim 24, characterized in that it is arranged to repeat the checking of connections until establishing new connections is allowed.

26. A device of claim 24, characterized in that it is arranged to inquire for other devices until said connection is established.

27. A device of claim 24, characterized in that it is arranged to alter the number of simultaneous connections allowed dependently on the current role of said device.

28. A device of claim 24, characterized in that if several new connections are allowed for said device and more than one response is received, said device is arranged to establish as many connections as allowed and available.

29. A device of claim 24 characterized in that said connection is established substantially utilizing Bluetooth technology.

30. A device of claim 29, characterized in that it is arranged to connect to a device not belonging to a current piconet, and arranged to still maintain existing connections in said current piconet by utilizing time division multiplexing.

31. A device of claim 24, characterized in that it is arranged to retain its role for a new connection.

32. A device of claim 24, characterized in that it is arranged to switch its role as a master or a slave for a new connection.

33. A device of claim 29, characterized in that it is arranged to inquire other devices by utilizing INQUIRY or INQUIRY SCAN procedures.

34. A device of claim 24, characterized in that it is substantially a personal communications device.

35. A device of claim 34, characterized in that it is substantially a GSM (Global System for Mobile communications) or UMTS (Universal Mobile Telecommunication System) terminal.

36. A device operable (206) in a wireless network, comprising processing means (214) and memory means (202) for processing and storing instructions and data, characterized in that said device is arranged to acquire parameters from existing connections, check if parameter related criteria for breaking a connection is met, and if that is the case, arranged to break an existing connection with criteria met, inquire for other devices in range, and connect to a device responded first.

37. A device of claim 36, characterized in that it is arranged to repeatedly acquire and check said parameters until the condition for a breaking a certain connection is met.

38. A device of claim 36, characterized in that said inquiry process is continued until a connection to another device is established.

39. A device of claim 36, characterized in that said it is arranged to intermittently update said criteria.

40. A device of claim 36, characterized in that it is arranged to utilize Bluetooth technology in said connections.

41. A device of claim 40, characterized in that it is arranged to connect to a device not belonging to a current piconet, and arranged to still maintain existing connections in said current piconet by utilizing time division multiplexing.

42. A device of claim 36, characterized in that it is arranged to retain its role for a new connection.

43. A device of claim 36, characterized in that it is arranged to switch its role as a master or a slave for a new connection.

44. A device of claim 40, characterized in that it is arranged to inquiry other devices by utilizing INQUIRY or INQUIRY SCAN procedures.

45. A device of claim 36, characterized in that it is substantially a personal communications device.

46. A device of claim 36, characterized in that it is substantially a GSM (Global System for Mobile communications) or UMTS (Universal Mobile Telecommunication System) terminal.
